(19) United States
(12) Patent Application Publication
(10) Pub. No.: US 2025/0005129 A1
(43) Pub. Date: Jan. 2, 2025

(54) SYSTEM AND METHOD FOR CONTEXTUAL MANAGEMENT OF MACHINE IDENTITIES

(71) Applicant: Oasis Security Ltd., Tel Aviv (IL)

(72) Inventors: Barak SHELEF, Tel Aviv (IL); Amit ZIMERMAN, Tel Aviv (IL); Dany BRIKMAN, Tel Aviv (IL)

(73) Assignee: Oasis Security Ltd., Tel Aviv (IL)

(21) Appl. No.: 18/345,696

(22) Filed: Jun. 30, 2023

(51) Int. Cl. G06F 21/44

(52) U.S. Cl. CPC G06F 21/44

(57) ABSTRACT

Techniques for identity management. A method includes creating a plurality of identity objects, wherein each identity object corresponds to an identity utilized in a computing environment; extracting common features from data retrieved from a plurality of data sources of a plurality of computing service providers, wherein each common feature is common to at least two of the identity objects; assigning metadata to each of the identity objects based on the common features; detecting a violation of an access policy with respect to at least one of the identity objects based on the assigned metadata; and mitigating the detected violation.

### TECHNICAL FIELD

The present disclosure relates generally to managing identities of computing entities such as systems or programs, and more particularly to contextually managing identities of computing entities.

### BACKGROUND

Identity management is a useful component of securing access to and from computing environments such as cloud environments. Specifically, modern computing needs often demand that organizations both track the identities of users interacting with their environments as well as their respective levels of access that vary between users. As a result, identity and access management (IAM) processes have become an increasingly important component of cloud security.

When an environment uses programs or functions available via different cloud providers, identities tend to diverge. This divergence makes it more difficult to accurately manage identities within the environment, which reduces cybersecurity of the environment.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for identity management. The method includes creating a plurality of identity objects, wherein each identity object corresponds to an identity utilized in a computing environment; extracting common features from data retrieved from a plurality of data sources of a plurality of computing service providers, wherein each common feature is common to at least two of the identity objects; assigning metadata to each of the identity objects based on the common features; detecting a violation of an access policy with respect to at least one of the identity objects based on the assigned metadata; and mitigating the detected violation.

Certain embodiments disclosed herein also include a non-transitory computer readable medium having stored thereon causing a processing circuitry to execute a process, the process comprising: creating a plurality of identity objects, wherein each identity object corresponds to an identity utilized in a computing environment; extracting common features from data retrieved from a plurality of data sources of a plurality of computing service providers, wherein each common feature is common to at least two of the identity objects; assigning metadata to each of the identity objects based on the common features; detecting a violation of an access policy with respect to at least one of the identity objects based on the assigned metadata; and mitigating the detected violation.

Certain embodiments disclosed herein also include a system for identity management. The system comprises: a processing circuitry; and a memory, the memory containing instructions that, when executed by the processing circuitry, configure the system to: create a plurality of identity objects, wherein each identity object corresponds to an identity utilized in a computing environment; extract common features from data retrieved from a plurality of data sources of a plurality of computing service providers, wherein each common feature is common to at least two of the identity objects; assign metadata to each of the identity objects based on the common features; detect a violation of an access policy with respect to at least one of the identity objects based on the assigned metadata; and mitigate the detected violation.

Certain embodiments disclosed herein include the method, non-transitory computer readable medium, or system noted above or below, further including or being configured to perform the following steps: creating a graph with respect to at least one identity object of the plurality of identity objects, wherein the violation is detected based further on the graph.

Certain embodiments disclosed herein include the method, non-transitory computer readable medium, or system noted above or below, wherein the access policy is defined with respect to at least one tag included among the assigned metadata, wherein the access policy is applied to each of the plurality of identity objects having the at least one tag.

Certain embodiments disclosed herein include the method, non-transitory computer readable medium, or system noted above or below, further including or being configured to perform the following steps: indexing the plurality of identity objects based on the common features; and correlating among the plurality of identity objects based on the common features, wherein the violation is detected based on the correlation.

Certain embodiments disclosed herein include the method, non-transitory computer readable medium, or system noted above or below, further including or being configured to perform the following steps: identifying a mitigation action template for the violation; generating an action set based on the mitigation action template; and executing at least one mitigation step based on the action set.

Certain embodiments disclosed herein include the method, non-transitory computer readable medium, or system noted above or below, wherein the action set is a first action set, further including or being configured to perform the following steps: generating at least one work package by grouping actions of the first action set and at least one second action set.

Certain embodiments disclosed herein include the method, non-transitory computer readable medium, or system noted above or below, further including or being configured to perform the following steps: documenting a plurality of mitigation steps performed when mitigating the detected violation; determining that at least one expected change failed to occur as a result of the documented plurality of mitigation steps; and performing at least one follow-up activity based on the at least one expected changes that failed to occur.

Certain embodiments disclosed herein include the method, non-transitory computer readable medium, or system noted above or below, further including or being configured to perform the following steps: integrating with the plurality of data sources by creating an integration for each of the plurality of data sources, wherein each integration includes code that integrates with a respective service in order to access at least one of the plurality of data sources; and retrieving the data from the plurality of data sources via the integration created for each of the plurality of data sources.

Certain embodiments disclosed herein include the method, non-transitory computer readable medium, or system noted above or below, wherein a secret is attached to each of the plurality of identity objects.

Certain embodiments disclosed herein include the method, non-transitory computer readable medium, or system noted above or below, wherein mitigating the detected violation further comprises causing performance of at least one task, each task corresponding to a respective identity object of the plurality of identity objects wherein each of the plurality of identity objects is owned by a respective owner entity, further including or being configured to perform the following steps: assigning each of the tasks to the owner entity of the identity object corresponding to the task.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIGS. 2A-D are logical component diagrams utilized to describe various disclosed embodiments.

FIG. 3 is a flowchart illustrating a method for contextual identity management according to an embodiment.

FIG. 4 is a flowchart illustrating a method for defining identities according to an embodiment.

FIG. 5 is a flowchart illustrating a method for mitigating cybersecurity threats using contextual identities according to an embodiment.

FIG. 6 is a schematic diagram of a hardware layer which may be utilized to realize at least a portion of the disclosed embodiments.

### DETAILED DESCRIPTION

The various disclosed embodiments include methods and systems for contextual identity management which may be utilized to manage identities in computing environments such as cloud computing environments. In particular, various disclosed embodiments provide improved techniques for managing machine identities, i.e., identities of computing entities such as systems, programs, portions thereof, and other computing entities realized at least partially through software instructions.

The disclosed embodiments utilize aggregated data from multiple sources of data that each collect data with respect to a computing environment in order to contextually enrich identity data, thereby allowing for managing identities with improved granularity. Various disclosed embodiments provide architecture designs and integration techniques which may be utilized to establish data aggregation via integration with a computing environment, thereby facilitating the disclosed identity management techniques.

In an embodiment, an identity is established for each of one or more computing entities operating within or with respect to a computing environment. In a further embodiment, the identity for each computing entity is an identity object to which an access policy is associated or otherwise applied. In yet a further embodiment, each identity further has associated metadata indicating aspects of the identity such as, but not limited to, name, policy, creation time, resources accessed by the identity, combinations thereof, and the like. Each identity may further have one or more associated secrets such as, but not limited to, passwords, access tokens, private keys, combinations thereof, and the like. Each secret may further have associated type-specific metadata indicating information about the secret such as, but not limited to, creation time, login time, expiration time, combinations thereof, and the like.

The disclosed embodiments include techniques for analyzing internal identities of machines, portions thereof, or other computing entities in order to uniquely identify such computing entities based on context. In this regard, it has been identified that many current service-based implementations utilize machine identities that are embedded deep within the software run by those machines. Accordingly, uniquely identifying these machines is a technical challenge. The disclosed embodiments leverage internal machine identity data in order to contextually enrich identity information, thereby allowing for uniquely identifying machines through contextual identities.

The disclosed embodiments provide various techniques which may be utilized to manage machine identities more securely. To this end, various disclosed embodiments facilitate the following management practices in order to allow for such improved security management.

First, having identified that secret sharing for operational convenience increases the number of endpoints which can be compromised in order to obtain the secret and therefore increases the attack surface, various disclosed embodiments facilitate management techniques which avoid or otherwise minimize sharing of secrets.

Second, having identified that identity sharing among workloads leads to inflation of access and increased area of impact for cyber threats, various disclosed embodiments facilitate management techniques which avoid or otherwise minimize sharing of identities. More specifically, some existing solutions reuse identities for convenience due to difficulties in maintaining identities, and the disclosed embodiments provide techniques for contextual identity management which allow for more easily maintaining identities that allows for avoiding identity reuse.

Third, having identified that existing entitlement tools only look at a snapshot with a limited view temporally, it has been identified that additional contextual data may be leveraged in order to identify more granular violations related to entitlement. More specifically, the contextual data utilized in accordance with various disclosed embodiments may be analyzed temporally, that is, with respect to different steps or otherwise with respect to different points in time. In this regard, more interesting potential violations related to entitlement may be identified, and it may be determined that an identity is being used incorrectly before following up later to solve any potential entitlement issues.

Fourth, it has been identified that security risks can be reduced by moving up the security ladder. That is, an organized approach to escalating security mitigation steps may be utilized in order to efficiently reduce security risks. If identities and secrets are unknown, administration may be improved by providing improved visibility. If secrets are shared or not rotated, secrets may be rotated and decoupled from identities. If secrets are not vaulted, they may be moved into vaults. If a secret can be replaced with identity federation, authentication may be performed using a federated identity instead. The disclosed embodiments, which provide contextual identity management, enable and facilitate these escalating steps.

As noted above, various disclosed embodiments provide techniques for performing integration in order to access contextual data used to contextually enrich identity data. In some further embodiments, identity context may be realized via graphing, and graphs may be created on demand when an entity to be contextually identified is provided.

In accordance with at least some embodiments, the integrated data sources from which contextual data is obtained may be utilized as the sources of truth instead of normalizing or otherwise standardizing the data from different integrated data sources in a unified format. That is, contextual data utilized in accordance with various disclosed embodiments may be obtained from each data source such that it is structured in the same or a similar way as that data is structured within the respective data source as integrated. Using the contextual data structured in the same way as in the integration may help with viability when designing a system using such contextual data by increasing the likelihood of succeeding on integrating new data sources. That is, solutions which change the structure of the contextual data may encounter more frequent challenges in development, and those challenges may be more severe and difficult to overcome than when the structure is transformed into a standardized or otherwise normalized structure across different data sources.

Additionally, the contextual data as originally structured may aid in integrating one or more systems or programs configured in accordance with the disclosed embodiments with an existing computing infrastructure. More specifically, it is noted that solutions which standardize or normalize data from different data sources would require manual classification of data in order to integrate the data sources into the computing infrastructure. This process is cumbersome, time-consuming, and subject to human error. Using the contextual data as originally structured allows for avoiding these issues.

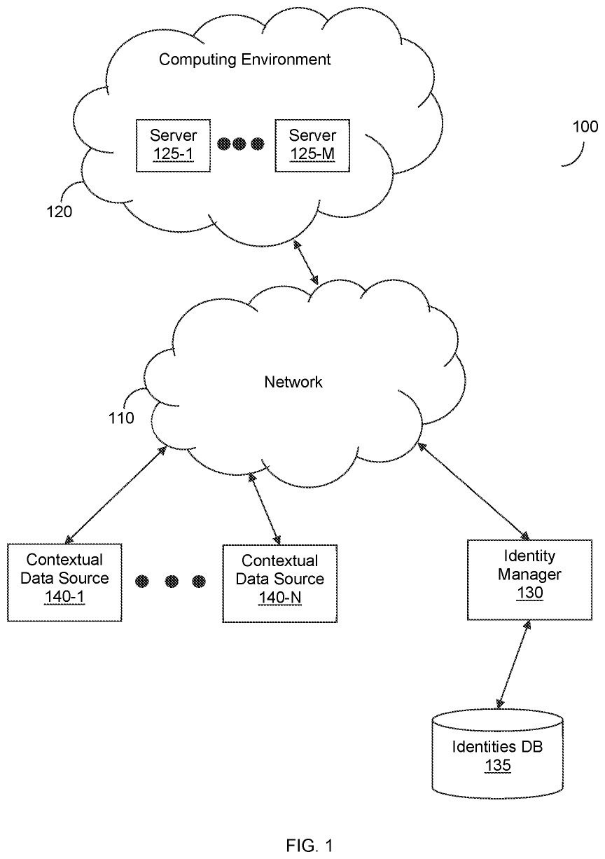

FIG. 1 shows an example network diagram 100 utilized to describe the various disclosed embodiments. In the example network diagram 100, components of a computing environment 120, an identity manager 130, and a plurality of contextual data sources 140-1 through 140-N (hereinafter referred to individually as a contextual data source 140 and collectively as contextual data sources 140, merely for simplicity purposes) communicate via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The computing environment 120 may be, but is not limited to, a cloud environment or other computing environment for which identities of machines are to be managed. To this end, the computing environment 120 may include, but is not limited to, one or more servers 125-1 through 125-M, where M is an integer having a value equal to or greater than 1 (hereinafter referred to individually as a server 125 or collectively as servers 125).

Any or all of the servers 125 may utilize identities for purposes such as, but not limited to, authentication (i.e., verifying that a computing entity is what it says it is), authorization (determining applicable permissions for a computing entity), and the like, such that accurately identifying a given computing entity may improve security within the computing environment. The computing entity may be a machine, system, device, program, function, or other computing component which may access services or functions requiring entity-based authentication or authorization.

The identity manager 130 is configured to manage identities in accordance with at least some of the disclosed embodiments. In particular, the identity manager 130 is configured to contextually enrich identity data in order to create contextually enriched identities for computing entities operating within or otherwise accessing components of the computing environment. The identity manager 130 may be further configured to resolving relationships, to graph identities, to mitigate cybersecurity threats, and to perform other functions in accordance with various disclosed embodiments.

The identities managed by the identity manager 130 may be identities of computing entities which utilize services realized, for example, via the servers 125 (e.g., by calling functions to those servers 125). As noted above, machines may have identities embedded within software run by those machines. Accordingly, in various disclosed embodiments, the identity manager 130 is configured to analyze software and other data stored on the servers 125 in order to resolve identities, to contextually enrich identities, both, and the like.

Identities resolved as described herein may be stored, for example, in an identities database (DB) 135 with which the identity manager 130 communicates. The identities database 135 may further store data related to those identities such as, but not limited to, graphs created as described herein. In particular, the identities database 135 may be or may include a contextual database (not shown) including contextual data retrieved with respect to identities managed as described herein.

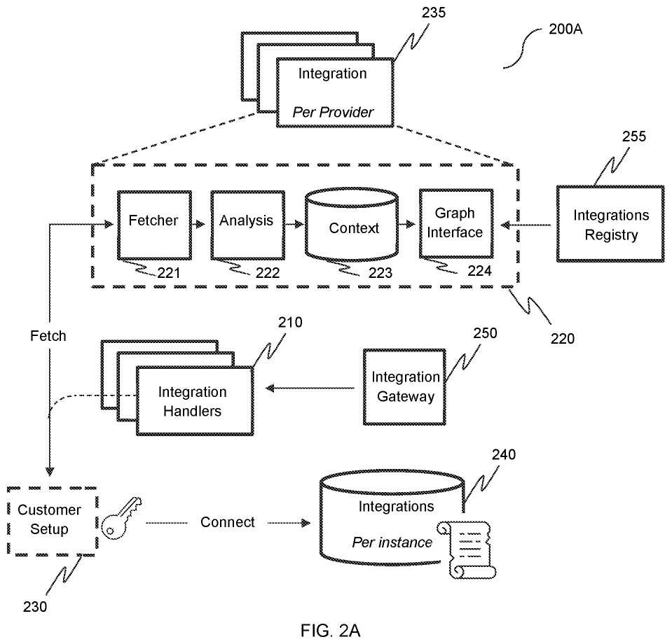

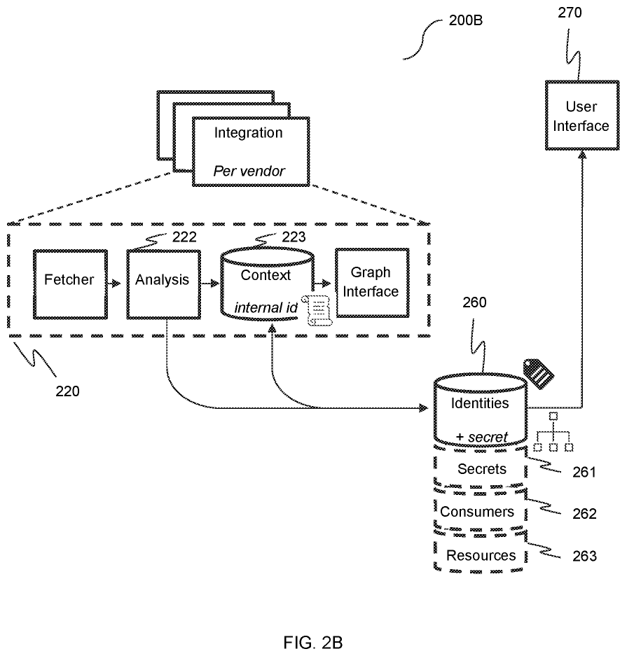

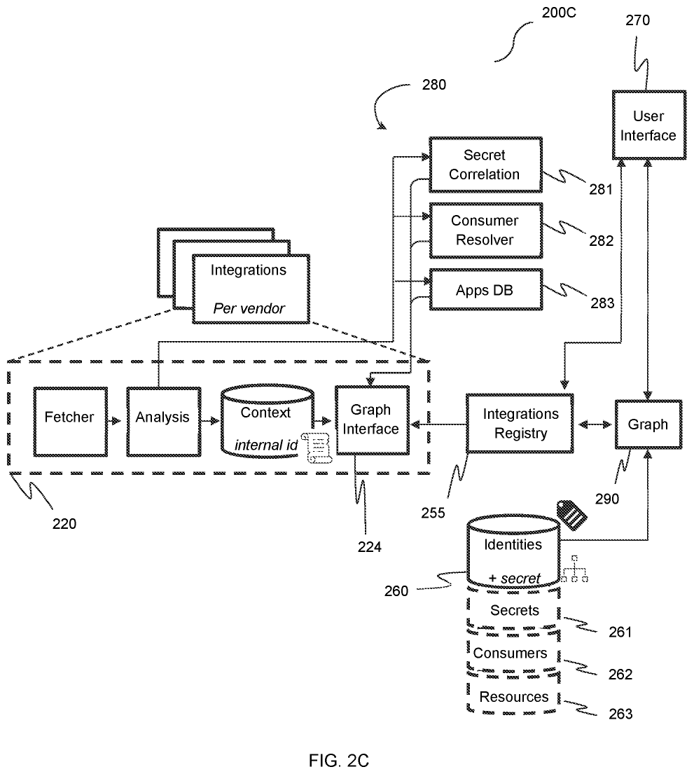

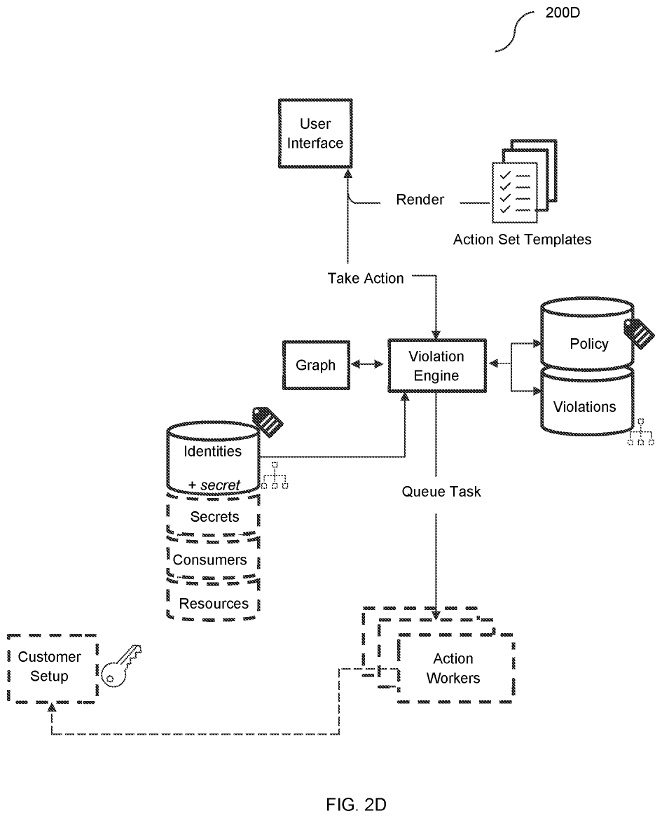

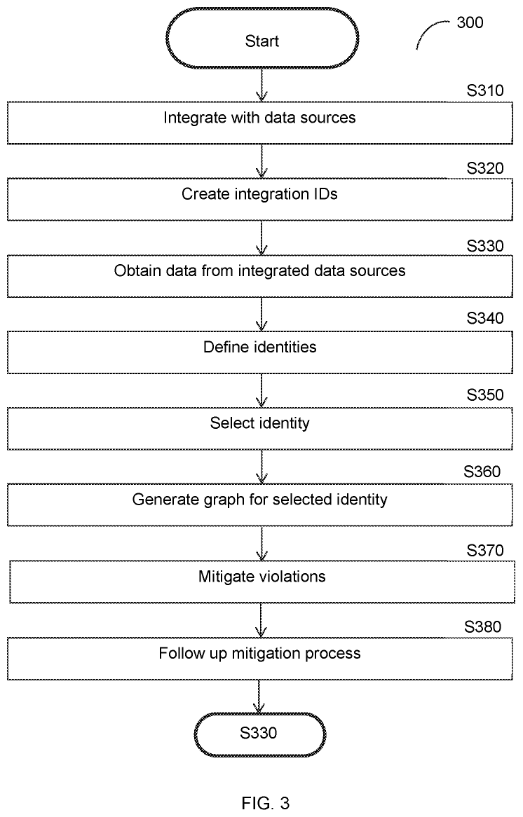

To implement the disclosed embodiments, the identity manager 130 is configured to access data to be used for contextually enriching identities, for example from the contextual data sources 140. To this end, the identity manager 130 is configured to connect to integrations (not depicted in FIG. 1), where each integration incorporates functions of one or more respective services (also not depicted in FIG. 1) through which data stored in the contextual data sources 140 is accessible. More specifically, as described further below with respect to FIGS. 2A and 3, the identity manager 130 is configured to connect to integrations of services offered by computing service providers and to fetch or otherwise retrieve data via such connected integrations. The contextual data retrieved by the identity manager 130 in this manner may be stored in the identities database 135.

The contextual data stored in the identities database 135 may be from different computing service providers, and different portions of that contextual data may be structured in the manner it was in while stored in the respective contextual data source 140. In this regard, the contextual data may be stored in its original format rather than in a standardized or unified format in order to facilitate integration and reduce inconsistencies which may otherwise hinder identity management, violation detection, and mitigation as described herein.

Moreover, the contextual data stored in the identities database 135 may be assigned respective internal identifiers. Such internal identifiers may be defined per-integration, and may therefore be utilized to deterministically correlate data from each vendor (i.e., contextual data related to integrations related to the same computing service provider may be correlated on the basis of their internal identifiers which correspond to respective integrations, which in turn correspond to respective computing service providers). Such correlation may allow for more accurate identity management and therefore violation detection.

In some implementations, the identities database 135 may further store an integrations registry (not shown) defined with respect to internal identifiers. Such an integrations registry may map sources of data to respective integrations such that data from a particular source may be accessed via its respective integration using its internal identifier.

It should be noted that FIG. 1 depicts an identity manager as a component deployed outside of the computing environment 120 for example purposes, but that at least some of the disclosed embodiments are not limited as such. In some embodiments, any or all of the disclosed embodiments may be implemented or otherwise realized via computing components deployed in the computing environment such as, but not limited to, the servers 125. Moreover, the functions of the identity manager may be realized via dedicated computing systems such as servers, via virtual machines, via programs or other software-based components deployed on computing systems, combinations thereof, and the like.

FIGS. 2A-D are logical component diagrams utilized to describe various disclosed embodiments.

FIG. 2A is a diagram 200A illustrating a flow of data during integration according to at least some disclosed embodiments. As illustrated in FIG. 2A, data is aggregated from multiple sources in order to facilitate contextual identity management in accordance with various disclosed embodiments. To this end, FIG. 2A depicts an integration handler 210 performing one or more integration logical components 220 and a customer setup 230. At least some of the data used by the integration logical components 220 is obtained via a connection between the customer setup 230 and one or more integration instances 240.

The integration handler 210 is configured to retrieve data (e.g., by fetching the data) from the integrations 230 via the integration instances 240. In some implementations, activities performed by the integration handler 210 are managed by an integration gateway 250. More specifically, the integration gateway 250 is configured to schedule and synchronize retrieval tasks, for example, tasks scheduled periodically.

The logical components 220 may include, but are not limited to, a fetcher 221, an analysis process 222, a context database 223, and a graph interface 224. The fetcher 221 retrieves data from one or more data sources (e.g., one or more of the contextual data sources 140, FIG. 1), for example based on fetch requests from the integration handler 210. The analysis process 222 analyzes the retrieved data in order to determine relevant parameters of the retrieved data.

Results of the analysis process 222 may be stored in the context database 223 for subsequent use, for example in order to contextually define identities as described herein. To this end, the context database 223 may further store internal identifiers as references for data stored therein which allows for deterministically correlating data from different computing service providers as described herein.

The graph interface 224 may provide an interface with which an integrations registry 250 may communicate. The integrations registry 250 may store a table mapping internal identifiers to respective integration instances 235 in order to allow external resources (e.g., the identity manager 130, FIG. 1) to retrieve data from appropriate integrations as needed.

FIG. 2B is a diagram 200B illustrating a flow of identity management utilizing integration according to at least some disclosed embodiments. As illustrated in FIG. 2B, the logical components 220 of integration are utilized to define identities 260, which in turn may be provided to a user interface 270. Also illustrated in FIG. 2B, the identities 260 may be defined with respect to information such as secrets 261, consumers 262, and computing resources 263. The identities 260 may be defined based on results of the analysis process 222 and data stored in the context database 223.

FIG. 2C is a diagram 200C illustrating a flow of contextual identification according to at least some disclosed embodiments. As illustrated in FIG. 2C, the logical components 220 are utilized in order to facilitate common feature identification processes 280 such as secret correlation 281, consumer resolver 282, and applications database (apps DB) analysis 283. The common feature identification processes 280 may be utilized in order to identify common features across different identities in order to aid in determining which identities may be of the same underlying computing entity. The results of common feature identification processes 280 may be provided to the graph interface 224 such that they can be accessed via the integrations registry 250.

Data accessed via the integrations registry 250 may be utilized in combination with the identities 260 in order to create a graph 290 as described herein. The graph 290 may be provided to the user interface 270 for display.

FIG. 2D is a diagram 200D illustrating a flow of violation detection and mitigation according to at least some disclosed embodiments. As illustrated in FIG. 2D, the graph 290 and the identities 260 are utilized by a violation engine 295 in order to detect one or more violations 296 based on one or more policies 297. Specifically, the policies 297 applied by the violation engine 295 may be policies attached to identities among the identities 260 which are monitored for violations by the violation engine 295. When a violation is detected by the violation engine 295, the violation engine 295 is configured to create sets of action steps for mitigation using one or more action set templates 298. To this end, the violation engine may cause display of such action set templates 298 or the action steps to a user via the user interface 270. Alternatively or in combination, the violation engine 295 may be configured to assign tasks to one or more action workers 299, which are configured to perform automated mitigation tasks via the customer setup 230.

FIG. 3 is a flowchart 300 illustrating a method for contextual identity management according to an embodiment. In an embodiment, the method is performed by the identity manager 130, FIG. 1.

At S310, integration is performed in order to integrate with data sources. The integration process results in one or more integrations, where each integration includes code which interfaces with a respective service and each service is configured to access one or more data sources. In some implementations, each integration may be with respect to a service offered by a vendor such as a cloud service provider. In some further implementations, multiple integrations may be created for any given vendor. In an embodiment, S310 may include executing integration connection instructions for each integration to be created. In a further embodiment, the integration connection instructions are vendor-specific such that different integration connection instructions may be executed for integrations of different computing service providers.

The integrations allow for accessing data available via services offered by computing service providers. To this end, in an embodiment, a system deployed in order to perform identity management (e.g., the identity manager 130 or one or more of the servers 125, FIG. 1) is integrated with each applicable service such that the system becomes configured to access the functions, data, or both, provided via that service. In a further embodiment, S310 includes creating an identity or role for the identity manager (e.g., the system configured to perform identity management or a program executed via such a system) with respect to each integration to be created and defining connection instructions for each provider of one or more services to be integrated.

Once the integrations have been created and connected to the identity manager system or program, data may be fetched via the connected integrations. A non-limiting example integration process is described in more detail above with respect to FIGS. 2A-D.

At S320, integration identifiers (IDs) are created. Specifically, an integration identifier is created for each integration created at S310. Each integration identifier is created so as to uniquely identify its respective integration, i.e., such that the integration identifier corresponds to that integration and only that integration.

At S330, data is obtained from the integrated data sources. In an embodiment, S330 includes fetching or otherwise retrieving the data via the integrations.

At S340, identities of computing entities are defined based on the data obtained from the integrated data sources. Each computing entity identity is an object to which an access policy is attached and may be created by the computing service provider integration which manages the identity. Further, each computing entity identity may have metadata attached thereto indicating information such as, but not limited to, name, policy, creation time, resources accessed (e.g., resources accessed via use of computing services), combinations thereof, and the like. Each identity may have additional pieces of data attached to them such as, but not limited to, secrets.

In various embodiments, each computing entity identity has multiple fields storing data related to the identity, use of the identity, changes to the identity, combinations thereof, and the like. Non-limiting examples for identity data in such fields may include, but are not limited to, internal identifier, name, source computing service provider, time of last use, time of last modification key type, combinations thereof, and the like.

In an embodiment, the data may be analyzed at S340 upon obtaining the data. In another embodiment, data may be obtained from the integrated data sources over time and analyzed in batches. In such embodiments, the data may be retrieved and stored into storage rather than databases in order to reduce computing resource consumption and to allow for adding features with respect to existing integrations without requiring again retrieving data and migrating data structure.

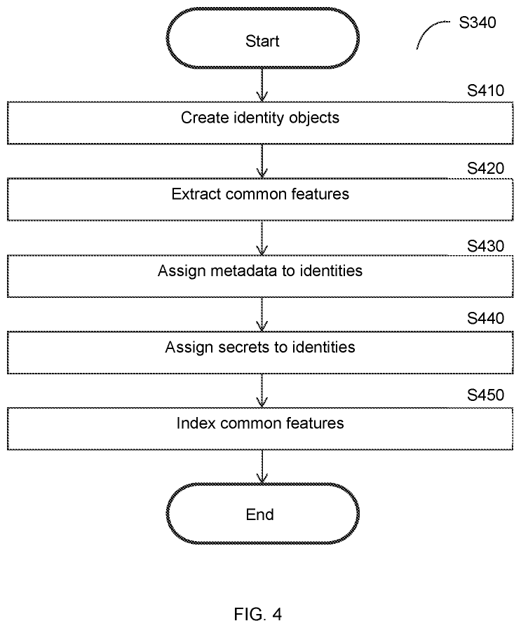

An example process for defining entities is described further below with respect to FIG. 4.

At S350, an identity is selected. The identity may be selected by a user, and may be an identity for which identity management is desired (e.g., an identity whose activities are to be monitored in order to detect potential violations of policies). Alternatively, the identity may be selected based on use, for example, based on an authentication or other activity which utilized identity for which contextually enriched identity data would aid in more accurately identifying the respective computing entity, for example in order to more accurately enforce access policies and detect potential violations thereof.

At S360, a graph is generated for the selected identity. In an embodiment, the graph includes nodes representing at least consumers, secret management systems, and resources, as well as edges representing communications or other connections between nodes. Consumers are clients who use the selected identity. Secret management systems such as key management systems (KMSs) are services used to store secrets of the selected identity to be used by consumers. Resources are objects accessible to the selected identity. Each node may be identified by a respective internal identifier as described herein as provided by the respective integrations. In some embodiments, graphs are generated on demand when an entity is selected.

A graph generated as described herein allows for representing an identity of a computing identity in context and provides a qualitative view rather than a quantitative view as would be provided by, for example, solutions utilizing an identity table. Consequently, the graph may allow for applying access policies in a manner which accounts for all potential connections of a computing entity represented by potentially different source identities, thereby allowing for identifying potentially new violations which may not be detected using identity data out of context.

In a further embodiment, the graph may be generated based further on standardized relationships, for example, the standardized relationships generated as discussed below with respect to FIG. 4.

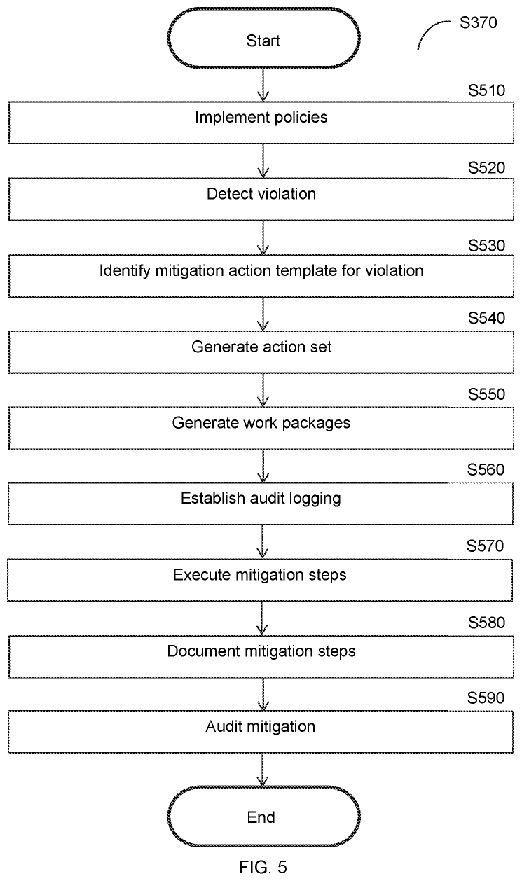

At S370, potential violations are mitigated with respect to the selected entity. In an embodiment, S370 may include analyzing the generated graph for potential violations, for example, violations of access policies which may be identified based on connections demonstrated in the graph. A non-limiting example process for mitigation is described further below with respect to FIG. 5.

At S380, one or more follow up activities are performed with respect to the mitigations performed at S370.

Alternatively or in combination, the follow up may be performed, for example, in order to run one or more entitlement processes. Such entitlement processes may allow for automating access controls and for providing follow up functionality in order to, for example, follow up on mitigation actions. In this regard, access policies or other policies utilized in accordance with various disclosed embodiments may define expiration time periods or otherwise define conditions for following up which may be monitored with respect to a contextually enriched identity graphed as discussed above.

As a non-limiting example, when the mitigation involves having a user update a password, the follow up activities may be defined with respect to a time period for updating after which it is checked whether the user has updated the password and, if so, the prior password (pre-update) is deleted; otherwise, an alert may be generated indicating the failure to update the password. As another non-limiting example, when a password is about to expire (e.g., when the password expires after a predetermined time period, the password may be about to expire when less than a threshold amount of time remains until the expiration time), an alert may be generated and sent to a user for updating the password. If action is not taken by that user within another predetermined period of time after sending such an alert, the alert may be escalated.

FIG. 4 is a flowchart S340 illustrating a method for defining identities according to an embodiment.

At S410, identity objects are created. Each identity object has metadata related to an underlying identity (e.g., an identity used with respect to an integration or otherwise with respect to a particular computing service provider).

Policies (e.g., access policies) may be attached to identities in order to define permissions or prohibitions with respect to actions, behaviors, access, or other circumstances for each identity. Deviations from these policies (e.g., performing an action which is forbidden or otherwise not permitted) may result in detecting a violation to be mitigated as described herein.

In some implementations, policies may be attached to identities indirectly, for example but not limited to, based on tags or other commonalities among identities. As a non-limiting example, each identity is assigned one or more tags based on common features, metadata, or both. In such an example, policies may be attached via tags insofar as each policy is applied with respect to identities having the tags with which the policy is defined.

At S420, common features are extracted. The common features are features of identities which may be used across different computing service providers or otherwise by different identities. In other words, common features are features which may be utilized by different identities of the same computing entity. As a non-limiting example, a computing entity may use the same secret across its different identities for different cloud service providers such that use of that secret is indicative that the identity which uses that secret relates to the same underlying computing entity as another identity which uses that secret.

The common features extracted at S420 may include, but are not limited to, secrets, consumers, correlated data from different data sources, combinations thereof, portions thereof, and the like. To this end, in an embodiment, S420 includes any or all of correlating secrets resolving common consumers, and correlated data from integrated data sources.

In an embodiment, secrets are correlated. Specifically, secrets utilized by consumers to log in as identities are correlated to each other. More specifically, use of the same secret across cloud providers may be identified within contextual data obtained from those computing service providers (e.g., from the contextual data sources 140, FIG. 1). Use of the same secret across cloud identifiers may help in identifying related identities for those computing service providers.

In an embodiment, common consumers are resolved. More specifically, appearances of consumers within contextual data may be resolved as being appearances of the same consumer based on available data such as, but not limited to, open source data. As a non-limiting example, a login Internet protocol (IP) address may be matched to information of a domain lookup site. As another non-limiting example, domains in which data demonstrating appearances of consumers may be matched to domains of known computing service providers.

In an embodiment, data obtained from integrated data sources are correlated with respect to available data which is common to different integrated data sources (e.g., data which is utilized by both of two different integrated data sources may be common to those data sources). As a non-limiting example, a cloud computing machine may be correlated to a relational database management system (RDBMS) based on data indicating a login of the cloud computing machine to the RDBMS.

The data correlated between integrated data sources may be stored in a database, for example, an applications (apps) database. To this end, such an apps database may be further populated with the common information used for correlation in order to enable the correlation. The common information may be provided via manual entry (e.g., by integrating with one or more asset management systems having manually entered data) or by populating the apps database with open source data (e.g., by integrating with one or more known IP addresses of services which are known to be used across different computing service providers such as a messaging service). To this end, in some embodiments, S420 further includes performing such integration with sources of common information data.

At S430, metadata is assigned to identities with respect to the created identity objects. The metadata indicates aspects of the identity such as, but not limited to, name, policy, creation time, resources accessed by the identity, user ownership or user responsibility for each identity (e.g., a user who is assigned to the identity as owner or otherwise responsible for the identity), combinations thereof, and the like. The kinds of metadata assigned to each identity may be type-specific metadata which vary depending on a type of the identity (e.g., a type of computing entity represented by the identity).

In an embodiment, the assigned metadata includes metadata indicating common features extracted at S420. Such metadata indicating the common features may therefore be utilized to index the respective identities, which in turn aids in correlating between identities with respect to the common features.

At S440, secrets are assigned to the identities with respect to the created identity objects. The assigned secrets may include, but are not limited to, passwords, access tokens, private keys, combinations thereof, and the like. In some embodiments, the secrets may further have metadata such as, but not limited to, type-specific metadata. Non-limiting examples of metadata for secrets include creation time, login time, expiration, and the like.

At S450, common features are indexed based on the metadata assigned to the identities. The indexing may be an organized list of common features defined with respect to identities for which each common feature is shared (i.e., multiple identities having the same feature in common may be indexed together under an entry for that common feature). The indexing allows for more efficiently correlating identities during subsequent processing, particularly when the correlation is used for generating graphs on demand as discussed above.

It should be noted that various steps depicted in FIG. 4 are shown in a particular order merely for example purposes, but that the disclosed embodiments are not necessarily limited to such an order. For example, any of the secrets correlation, resolution of common consumers, and correlation of records from integration may be performed in a different order without departing from the scope of the disclosure.

FIG. 5 is a flowchart S370 illustrating a method for mitigating cybersecurity threats using contextual identities according to an embodiment.

At S510, one or more policies are implemented with respect to a computing entity. The policies may include, but are not limited to, access policies (e.g., access policies attached to an identity as discussed above), other policies defined with respect to activities of certain computing entities identified via identities, both, and the like. More specifically, the policies define violations with respect to certain actions, states, behaviors, combinations thereof, portions thereof, and the like.

At S520, a violation is detected based on the policies. In an embodiment, S520 includes monitoring activity with respect to the computing entity via an identity of the computing entity. In a further embodiment, the activity is monitored with respect to connections represented in a graph (e.g., connections represented via edges in the graph) in order to determine whether such connections or otherwise communications via nodes represented in the graph violate the policies.

In an embodiment, S520 includes enforcing policies (e.g., access policies) attached to each identity. Each access policy defines one or more computing resources (e.g., data, software applications, services, etc.) as well as one or more conditions of access that define which resources may be accessed and what conditions such access is subject to. The access policies may be client defined or may be assigned based on, for example but not limited to, a type of computing entity to which each identity is assigned. In various implementations, policies are attached via tagging or otherwise based on metadata. In such implementations, each policy is defined with respect to one or more tags or otherwise with respect to a combination of metadata, and each identity having the tags or metadata defined in a given policy is considered to be attached to the policy such that the policy is enforced with respect to the attached identity.

In some implementations, identities may be federated between an identity provider (e.g., the identity manager 130, FIG. 1) and a client. In such implementations, the client may define an access policy for attachment to an identity managed elsewhere (e.g., by defining the policy with respect to tags which may be included in identities managed elsewhere). As a non-limiting example described with respect to the example network diagram of FIG. 1, a client of one of the servers 125 in the computing environment 120 may attach an access policy to an identity managed by the identity manager 130.

At S530, a mitigation action template is identified with respect to the violation. In an embodiment, each type of violation has assigned thereto a predetermined mitigation action template. When a violation of that type is detected, the mitigation action template may be identified, for example, by looking up the template in a dataset indicating violation types and their assigned mitigation action templates.

At S540 an action set for mitigating the violation is generated based on the mitigation action template. In an embodiment, S540 includes identifying violation parameters of the violation and generating the action set based on the mitigation action template and the violation parameters. The violation parameters may be generated and attached to the violation by the policy which was used to detect the violation. The action set includes steps which can either be executed by a user or on a system deployed with respect to a computing environment in order to mitigate the violation.

At S550, one or more work packages are generated based on the action set. More specifically, work packages may be generated in order to group mitigation steps of the action set with mitigation steps of other action sets created for other violations. To this end, each work package is a group of mitigation steps of multiple action sets that is grouped based on commonalities between action sets of different violations. In a further embodiment, violations having action sets that are similar (e.g., define similar mitigation steps) or otherwise overlap (e.g., including one or more of the same mitigation steps) may be identified, and action sets of those identified violations may be grouped into work packages. Similarities between action sets of violations may be determined based on, for example but not limited to, commonalities among mitigation action templates identified for each violation, commonalities among mitigation steps between action sets, commonalities between locations (e.g., locations within a computing infrastructure) on which mitigation steps are to be performed according to action sets, commonalities between computing resources on which mitigation steps are to be performed according to action sets, combinations thereof, portions thereof, and the like. Grouping similar or overlapping action sets allows for reducing some redundant actions during mitigation, thereby improving efficiency of mitigation.

At S560, audit logging is established. In an embodiment, the audit logging may be established with respect to a graph created as described above or otherwise with respect to communications, connections, or other relationships between one or more identities and one or more computing resources or other portions of computing infrastructure accessed by those identities. To this end, S560 may include establishing monitoring with respect to identities of a computing entity. The audit logging may be established so as to collect data related to changes in the computing resources or other portions of the computing infrastructure which may be utilized, for example, in order to determine whether mitigation actions were successful.

At optional S570, mitigation actions are executed using the generated action set. The mitigation actions are performed in order to mitigate potential exploitation of vulnerabilities through identity or access misuse and may include, but is not limited to, revoking access, changing access permissions, ceasing communications, combinations thereof, portions thereof, and the like.

In an embodiment, the mitigation actions are streamlined. To this end, in an embodiment, S570 further includes deploying or otherwise communicating with one or more task management systems in order to send data indicating potential mitigation actions to be performed, where the task management systems are configured to allocate mitigation actions and notify recipients of which mitigation actions they are to perform. In various implementations, the mitigation actions are streamlined into existing procedures, for example but not limited to, existing procedures of a customer realized via one or more task management systems deployed in environments operated by the customer.

In a further embodiment, at least some of the tasks are assigned to owners of respective identities or other entities who are responsible for those identities, where tasks related to certain identities are assigned to the respective owners of those identities. To this end, in an embodiment where each task corresponds to a respective identity, S570 includes assigning one or more of the tasks among the mitigation actions to entities responsible for managing the corresponding identities of those tasks.

At S580, mitigation steps are documented. In an embodiment, S580 includes storing data indicating which mitigation steps were performed and with respect to which computing resources or portions of a computing infrastructure those mitigation steps were performed. Such data may be referenced during subsequent processing, for example during mitigation auditing at S590, in order to check for potential failures to mitigate.

At S590, mitigation auditing is performed with respect to the documented mitigation steps and the audit logging. As noted above, audit logging may be established in order to monitor changes (e.g., changes to a computing infrastructure, changes to computing resources, changes in behavior, etc.) with respect to identities of a computing entity. To this end, in an embodiment, S590 includes applying one or more mitigation auditing rules based on the documented mitigation steps and audit logs created during the audit logging in order to determine whether mitigation actions were successful. Further, the mitigation auditing rules may define success of mitigation actions, for example, with respect to expected changes that would occur when mitigation actions are successful. Such expected changes may be predetermined changes based on, for example, types of mitigation actions, where mitigation actions are performed relative to the computing infrastructure or with respect to one or more process flows, which computing resources are acted upon during mitigation, combinations thereof, and the like.

As noted above, in at least some implementations, follow-up activities may be defined with respect to mitigation actions. The audit logs may be analyzed with respect to the conditions for performing these follow-up activities in order to determine whether and which follow-up activities are to be performed. In this regard, the audit logs may be checked for certain changes in computing resources that would be expected based on performing certain mitigation actions, and follow-up activities may be performed if the changes have not been realized, for example, if the audit logs do not indicate those changes.

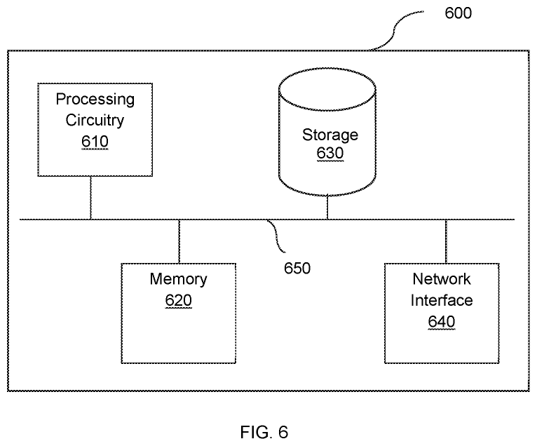

FIG. 6 is an example schematic diagram of a hardware layer 600 which may be utilized to realize at least a portion of the disclosed embodiments. The hardware layer 600 includes a processing circuitry 610 coupled to a memory 620, a storage 630, and a network interface 640. In an embodiment, the components of the hardware layer 600 may be communicatively connected via a bus 650.

As a non-limiting example, the hardware layer 600 may be utilized as a hardware layer through which the identity manager 130, FIG. 1, is implemented. As another non-limiting example, any or all of the disclosed embodiments may be realized via one or more computing systems deployed in a computing environment such as the servers 125, FIG. 1. Accordingly, in such an example, the hardware layer 600 may be utilized by any such computing systems.

The processing circuitry 610 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 620 may be volatile (e.g., random access memory, etc.), non-volatile (e.g., read only memory, flash memory, etc.), or a combination thereof.

In one configuration, software for implementing one or more embodiments disclosed herein may be stored in the storage 630. In another configuration, the memory 620 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform the various processes described herein.

The storage 630 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 640 allows the hardware layer 600 to communicate with, for example, the computing environment 120, the identities database 135, the contextual data sources 140, combinations thereof, and the like.

It should be understood that the embodiments described herein are not limited to the specific architecture illustrated in FIG. 6, and other architectures may be equally used without departing from the scope of the disclosed embodiments.

It should be noted that various disclosed embodiments are described with respect to machine identities, but that at least some disclosed embodiments are not necessarily limited to entire machines or otherwise to entire computing systems. At least some disclosed embodiments may be equally applicable to portions of machines or computing systems such as, but not limited to, virtual machines, software containers, programs, functions, combinations thereof, portions thereof, and the like. Generally speaking, a computing entity whose identity may be managed in accordance with at least some disclosed embodiments is a computing entity which operates using or based on one or more sets of software instructions, i.e., computer-executable code.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for identity management, including:
creating a plurality of identity objects, wherein each identity object corresponds to an identity utilized in a computing environment;
extracting common features from data retrieved from a plurality of data sources of a plurality of computing service providers, wherein each common feature is common to at least two of the identity objects;
assigning metadata to each of the identity objects based on the common features;
detecting a violation of an access policy with respect to at least one of the identity objects based on the assigned metadata; and
mitigating the detected violation.

2. The method of claim 1, further comprising:
creating a graph with respect to at least one identity object of the plurality of identity objects, wherein the violation is detected based further on the graph.

3. The method of claim 1, wherein the access policy is defined with respect to at least one tag included among the assigned metadata, wherein the access policy is applied to each of the plurality of identity objects having the at least one tag.

4. The method of claim 1, further comprising:
indexing the plurality of identity objects based on the common features; and
correlating among the plurality of identity objects based on the common features, wherein the violation is detected based on the correlation.

5. The method of claim 1, wherein mitigating the detected violation further comprises:
identifying a mitigation action template for the violation;
generating an action set based on the mitigation action template; and
executing at least one mitigation step based on the action set.

6. The method of claim 5, wherein the action set is a first action set, further comprising:
generating at least one work package by grouping actions of the first action set and at least one second action set.

7. The method of claim 1, further comprising:
documenting a plurality of mitigation steps performed when mitigating the detected violation;
determining that at least one expected change failed to occur as a result of the documented plurality of mitigation steps; and
performing at least one follow-up activity based on the at least one expected change that failed to occur.

8. The method of claim 1, further comprising:
integrating with the plurality of data sources by creating an integration for each of the plurality of data sources, wherein each integration includes code that integrates with a respective service in order to access at least one of the plurality of data sources; and
retrieving the data from the plurality of data sources via the integration created for each of the plurality of data sources.

9. The method of claim 1, wherein a secret is attached to each of the plurality of identity objects.

10. The method of claim 1, wherein mitigating the detected violation further comprises causing performance of at least one task, each task corresponding to a respective identity object of the plurality of identity objects wherein each of the plurality of identity objects is owned by a respective owner entity, further comprising:
assigning each of the tasks to the owner entity of the identity object corresponding to the task.

11. A non-transitory computer readable medium having stored thereon instructions for causing a processing circuitry to execute a process, the process comprising:
creating a plurality of identity objects, wherein each identity object corresponds to an identity utilized in a computing environment;
extracting common features from data retrieved from a plurality of data sources of a plurality of computing service providers, wherein each common feature is common to at least two of the identity objects;
assigning metadata to each of the identity objects based on the common features;
detecting a violation of an access policy with respect to at least one of the identity objects based on the assigned metadata; and
mitigating the detected violation.

12. A system for identity management, comprising:
a processing circuitry; and
a memory, the memory containing instructions that, when executed by the processing circuitry, configure the system to:
create a plurality of identity objects, wherein each identity object corresponds to an identity utilized in a computing environment;
extract common features from data retrieved from a plurality of data sources of a plurality of computing service providers, wherein each common feature is common to at least two of the identity objects;
assign metadata to each of the identity objects based on the common features;
detect a violation of an access policy with respect to at least one of the identity objects based on the assigned metadata; and
mitigate the detected violation.

13. The system of claim 12, wherein the system is further configured to:
create a graph with respect to at least one identity object of the plurality of identity objects, wherein the violation is detected based further on the graph.

14. The system of claim 12, wherein the access policy is defined with respect to at least one tag included among the assigned metadata, wherein the access policy is applied to each of the plurality of identity objects having the at least one tag.

15. The system of claim 12, wherein the system is further configured to:
index the plurality of identity objects based on the common features; and
correlate among the plurality of identity objects based on the common features, wherein the violation is detected based on the correlation.

16. The system of claim 12, wherein the system is further configured to:
identify a mitigation action template for the violation;
generate an action set based on the mitigation action template; and
execute at least one mitigation step based on the action set.

17. The system of claim 6, wherein the action set is a first action set, wherein the system is further configured to:
generate at least one work package by grouping actions of the first action set and at least one second action set.

18. The system of claim 12, wherein the system is further configured to:
document a plurality of mitigation steps performed when mitigating the detected violation;
determine that at least one expected change failed to occur as a result of the documented plurality of mitigation steps; and
perform at least one follow-up activity based on the at least one expected change that failed to occur.

19. The system of claim 12, wherein the system is further configured to:
integrate with the plurality of data sources by creating an integration for each of the plurality of data sources, wherein each integration includes code that integrates with a respective service in order to access at least one of the plurality of data sources; and
retrieve the data from the plurality of data sources via the integration created for each of the plurality of data sources.

20. The system of claim 12, wherein a secret is attached to each of the plurality of identity objects.

21. The system of claim 12, wherein mitigating the detected violation further comprises causing performance of at least one task, each task corresponding to a respective identity object of the plurality of identity objects wherein each of the plurality of identity objects is owned by a respective owner entity, wherein the system is further configured to:
assign each of the tasks to the owner entity of the identity object corresponding to the task.
